(19) United States
(12) Patent Application Publication
(10) Pub. No.: US 2025/0276374 A1
(43) Pub. Date: Sep. 4, 2025

(54) POWDER MONITORING FOR ADDITIVE MANUFACTURING SYSTEMS

(71) Applicants: Rolls-Royce Corporation, Indianapolis, IN (US); Rolls-Royce plc, London (GB)

(72) Inventors: Scott Nelson, Indianapolis, IN (US); David James Puhl, Indianapolis, IN (US); Clive Grafton-Reed, London (GB); Peter E. Daum, Indianapolis, IN (US); Robert F. Proctor, Indianapolis, IN (US); Christopher Paul Heason, London (GB)

(21) Appl. No.: 18/593,294

(22) Filed: Mar. 1, 2024

(51) Int. Cl. B22F 10/85; B22F 10/34; B22F 12/90; B33Y 10/00; B33Y 30/00; B33Y 50/02

(52) U.S. Cl. CPC B22F 10/85; B22F 10/34; B22F 12/90; B33Y 50/02; B33Y 10/00; B33Y 30/00

(57) ABSTRACT

An additive manufacturing system includes an energy delivery device configured to deliver energy to a build surface of a component to form a melt pool in the build surface of the component, a powder delivery device configured to direct a powder stream toward the melt pool, at least one sensor configured to generate sensor data, and a computing device. The computing device may be configured to receive the sensor data from the at least one sensor, determine, based on the sensor data, at least one powder flow characteristic, and generate a signal indicative of the at least one powder flow characteristic. The computing device may be further configured to control, based on the at least one powder flow characteristic, the energy delivery device and the powder delivery device to deposit a plurality of layers based on a set of deposition parameters.

### TECHNICAL FIELD

The disclosure relates to additive manufacturing techniques.

### BACKGROUND

Additive manufacturing generates three-dimensional structures through addition of material layer-by-layer or volume-by-volume to form the structure, rather than removing material from an existing component to generate the three-dimensional structure. Additive manufacturing may be advantageous in many situations, such as rapid prototyping, forming components with complex three-dimensional structures, or the like. In some examples, additive manufacturing may utilize powdered materials and may melt or sinter the powdered material together in predetermined shapes to form the three-dimensional structures. In addition to initial fabrication, additive manufacturing techniques may include subsequent machining processes to finish a component.

### SUMMARY

The disclosure describes additive manufacturing systems, and methods for operating additive manufacturing systems, that monitor powder flow. For example, at least one powder flow characteristic (e.g., powder velocity) may affect deposit quality and/or cause deviation of deposition parameters from nominal targets. However, determining powder velocity at one or more points along a powder flow path (e.g., in real-time or near real-time) presents challenges. In some examples, at least one sensor (e.g., an acoustic sensor, an in-line gas flow sensor, or a powder flow monitor), may be used to detect at least one powder flow characteristic. In this way, the additive manufacturing systems described herein may enable monitoring and control of powder flow in additive fabrication of a component. In turn, monitoring and control of powder flow may promote quality of production and reduce deviation of a product from a nominal product geometry.

In some examples, the disclosure describes an additive manufacturing system that includes an energy delivery device, a powder delivery device, at least one sensor, and a computing device. The energy delivery device is configured to deliver energy to a build surface of a component to form a melt pool in the build surface of the component. The powder delivery device is configured to direct a powder stream toward the melt pool. The at least one sensor is configured to generate sensor data. The computing device may be configured to receive the sensor data from the at least one sensor, determine, based on the sensor data, at least one powder flow characteristic, and generate a signal indicative of the at least one powder flow characteristic. The computing device may be further configured to control, based on the at least one powder flow characteristic, the energy delivery device and the powder delivery device to deposit a plurality of layers based on a set of deposition parameters.

In some examples, the disclosure describes a method that includes receiving, by a computing device, sensor data from at least one sensor of an additive manufacturing system. The method may further include determining, by the computing device, based on the sensor data, at least one powder flow characteristic. The method may further include generating, by the computing device, a signal indicative of the at least one powder flow characteristic. The method may further include controlling, by the computing device, based on the at least one powder flow characteristic, an energy delivery device and a powder delivery device of the additive manufacturing system to deposit a plurality of layers based on a set of deposition parameters.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual block diagram illustrating powder monitoring aspects of an example additive manufacturing system configured to monitor powder flow of a powder used to fabricate a component during an additive manufacturing technique.

FIG. 2 is a conceptual and schematic diagram illustrating an example powder flow monitoring system configured to monitor powder flow between a powder delivery device and a build surface during the additive manufacturing technique.

FIG. 3 is a process flow diagram illustrating a mass flux and heat flux monitoring and control technique.

FIG. 4 is a flowchart illustrating an example technique for fabricating a component while monitoring a powder flow characteristic.

### DETAILED DESCRIPTION

The disclosure generally describes techniques and systems for monitoring at least one powder flow characteristic during a blown powder additive manufacturing technique (e.g., directed energy deposition, DED). For example, at least one powder flow characteristic (e.g., powder velocity) may be unknown at a given position in an additive manufacturing system and/or point of time during fabrication. Further, it may be difficult to control process parameters to achieve a predetermined powder flow characteristic without determining values of the powder flow characteristic during different process conditions or fabrication stages.

During blown powder additive manufacturing, a component is built up by adding material to the component in sequential layers, such that the final component is composed of a plurality of layers of material. In blown powder additive manufacturing techniques for forming components from metals or alloys, an energy source may direct energy at a substrate to form a melt pool, and a powder delivery device may deliver a powder to the melt pool. At least some of the powder at least partially melts and is joined to the melt pool and, thus, the substrate. Powder velocity influences deposit quality and the occurrence of adverse or abnormal events, for example, in flow of powder toward the substrate, or interaction of powder with the melt powder, or other events. For example, powder velocity may affect many process responses, such as build quality, build height, or layer thickness. Component geometry also influences powder flow (e.g., nozzle sizes), and powder flow beyond a nominal range may result in an abnormal interaction of powder with a component (for example, leading to blockage or plugging).

In accordance with techniques of the disclosure, an additive manufacturing system may include at least one sensor for detecting at least one powder flow characteristic. By monitoring at least one powder flow characteristic, the systems described herein may enable a more efficient use of powder in fabricating a component, more effectively and/or efficiently control operation of additive manufacturing. For example, at least one sensor may be used to monitor a velocity of a powder cloud in situ or ex situ. Powder velocity (or another powder flow characteristic) may be correlated to at least one deposit quality metric or an abnormal event (e.g., clogging, spattering, or plugging). Process parameters may be controlled (e.g., by adjusting powder flow rate, carrier gas pressure, or carrier gas flow rate) based on at least one powder flow characteristic detected by at least one sensor. Monitoring powder flow thus may promote product quality, control of additive fabrication within specifications, a better understanding of relation of process parameters and product quality, for selection of appropriate components or for using a wider range of components (e.g., a variety of a nozzle) to be used to achieve a predetermined powder velocity.

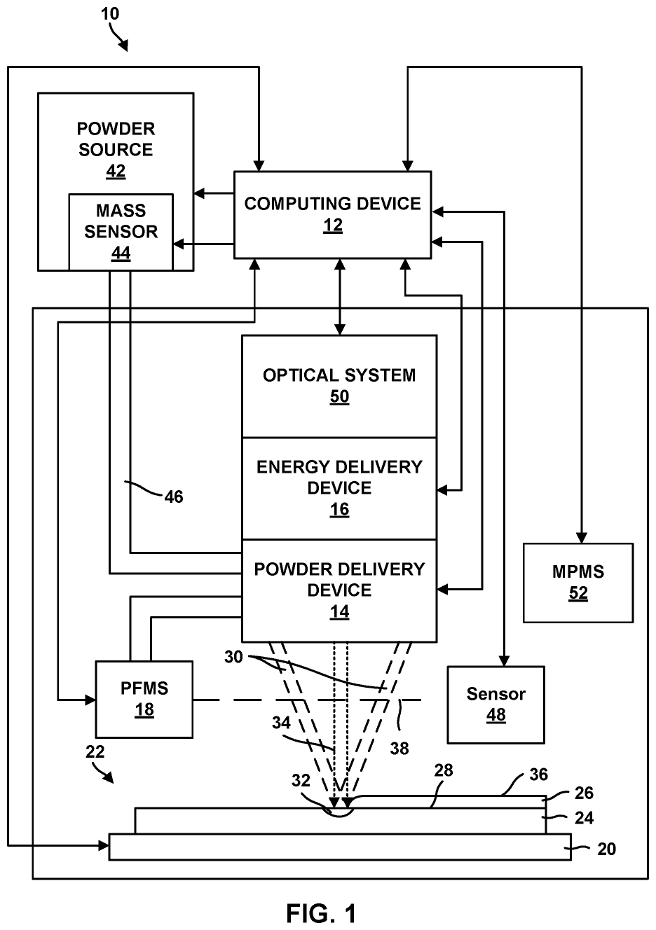

FIG. 1 is a conceptual block diagram illustrating an example additive manufacturing system 10 configured to monitor powder flow of a powder used to fabricate a component 22 during an additive manufacturing technique. In the example illustrated in FIG. 1, additive manufacturing system 10 includes a computing device 12, a powder delivery device 14, an energy delivery device 16, a powder flow monitoring system (PFMS) 18, a stage 20, an optical system 50, a melt pool monitoring system (MPMS) 52, a powder source 42, a powder source mass sensor 44, and a sensor 48.

Stage 20 is configured to position component 22 during an additive manufacturing process. In some examples, stage 20 is movable relative to energy delivery device 16 and/or energy delivery device 16 is movable relative to stage 20. Similarly, stage 20 may be movable relative to powder delivery device 14 and/or powder delivery device 14 may be movable relative to stage 20. Stage 20 may be configured to selectively position and restrain component 22 in place relative to stage 20 during manufacturing of component 22.

Powder source 42 is the source of powder for powder stream 30. Powder source 42 may include any suitable container or enclosure, such as a hopper, configured to hold powder. Powder source 42 also may include a mechanism for entraining the powder in a gas flow. For instance, powder source 42 may be coupled to a gas source, which provides a gas flowing through powder source 42 and entraining powder within the gas flow. Additionally, or alternatively, powder source 42 may include an agitator configured to agitate the powder and increase entrainment of the powder in the gas stream. System 10 may include a powder source mass sensor 44 associated with powder source 42. Powder source mass sensor 44 may be configured to quantify loss of mass in the powder source 42 or, alternatively, a mass flow out of powder source 42.

Powder source 42 is fluidically coupled to powder delivery device 14 via a flow path 46. Flow path 46 may include any suitable structure(s) defining an enclosed flow between powder source 42 and powder delivery device, including conduit, pipe, tubes, or the like. Although not shown in FIG. 1, for at least part of flow path 46 between powder source 42 and nozzles of powder delivery device 14, flow path 46 may split into multiple, parallel sections, e.g., one for each nozzle. Further, although not shown in FIG. 1, in some examples, flow path 46 may include one or more nozzles for controlling flow through flow path 46 as a whole or portions of flow path 46 (e.g., a section associated with a particular nozzle of powder delivery device 14).

Powder delivery device 14 may be configured to deliver powder to selected locations of component 22 being formed via a powder stream 30. Powder delivery device 14 may include one or more nozzles that each output powder, such that the combined powder defines powder stream 30 focused at a focus plane. As powder delivery device 14 is movable in the z-axis shown in FIG. 1 relative to component 22, the focal plane of powder delivery device 14 also may be movable in the z-axis relative to component 22, such that the focus plane may be controlled to be substantially coincident with a build surface 28 of component 22.

In some examples, powder delivery device 14 may be mechanically coupled or attached to energy delivery device 16 to facilitate delivery of powder stream 30 and energy 34 for forming melt pool 32 to substantially the same location adjacent to component 22. Energy delivery device 16 may include an energy source, such as a laser source, an electron beam source, plasma source, or another source of energy 34 that may be absorbed by component 22 to form a melt pool 32 and/or be absorbed by powder in powder stream 30 to be added to component 22. Example laser sources include a CO laser, a CO₂ laser, a Nd:YAG laser, or the like. In some examples, the energy source may be selected to provide energy with a predetermined wavelength or wavelength spectrum that may be absorbed by component 22 and/or the powder to be added to component 22 during the additive manufacturing technique.

In some examples, energy delivery device 16 also includes an energy delivery head, which is operatively connected to the energy source. The energy delivery head may aim, focus, or direct energy 34 toward predetermined positions at or adjacent to a surface of component 22 during the additive manufacturing technique. As described above, in some examples, the energy delivery head may be movable in at least one dimension (e.g., translatable and/or rotatable) under control of computing device 12 to direct the energy toward a selected location at or adjacent to a surface of component 22.

As shown in FIG. 1, energy delivery device 16 may be arranged or configured such that energy 34 and powder stream 30 both exit from a common deposition head and are directed toward build surface 28. For instance, energy 34 may pass through a central channel within the deposition head and exit a central aperture in the deposition head, while fluidized powder may flow through internal channels and powder nozzle(s) for forming powder stream 30 and directing powder stream 30 toward build surface 28. At least some of the powder in powder stream 30 may impact a melt pool 32 in component 22, and at least some of the powder that impacts melt pool 32 may be joined to component 22.

During additive manufacturing, component 22 is built up by adding material to component 22 in sequential layers. The final component is composed of a plurality of layers of material. Energy delivery device 16 may direct energy 34 at first layer 24 to form melt pool 32. Powder delivery device 14 may deliver powder stream 30 to melt pool 32, where at least some of the powder at least partially melts and is joined to first layer 24. Melt pool 32 cools as energy 34 is no longer delivered to that location of first layer 24 (e.g., due to energy delivery device 16 scanning energy 34 over the surface of first layer 24). The temperature and cooling rate of melt pool 32 and the surrounding areas of first layer 24 affect the microstructure of the component 22 formed using the additive manufacturing technique.

System 10 may include both mass flow monitoring and heat flow monitoring. To provide mass flow monitoring, system 10 may include powder flow monitoring system (PFMS) 18. PFMS 18 is configured to image at least a portion of powder stream 30 to detect powder flowing between powder delivery device 14 and build surface 28. For example, PFMS 18 may include an illumination device and an imaging device. In some examples, the illumination device may include one or more light sources. For instance, the illumination device may include one or more structured light devices, such as one or more lasers. The illumination device is configured to illuminate a plane of powder stream 30 at image plane 38, e.g., a plane substantially perpendicular to an axis extending between powder delivery device 14 and build surface 28. The imaging device of PFMS 18 is configured to image at least some of the illuminated powder. The imaging device may have a relatively high data acquisition speed (e.g., frame rate), such as greater than 1000 Hz. To provide heat flow monitoring, system 10 may include melt pool monitoring system (MPMS) 52. MPMS 52 is configured to image at least a portion of melt pool 32 to detect parameters, such as size, temperature, or shape, of melt pool 32. For example, MPMS may be communicatively coupled to optical system 50 for observing thermal emissions around melt pool 32 and a thermal camera for monitoring a size and/or temperature of melt pool 32.

Optical system 50 may include an imaging device and an associated optical train, which senses emissions at or near component 22 during the additive manufacturing technique. For example, optical system 50 may include a visible light imaging device, an infrared imaging device, or an imaging device that is configured (e.g., using a filter) to image a specific wavelength or wavelength range. The optical train may include one or more reflective, refractive, diffractive optical components configured to direct light to the imaging device. For example, the optical train may be configured to direct light from near component 22 and/or melt pool 32 to the imaging device.

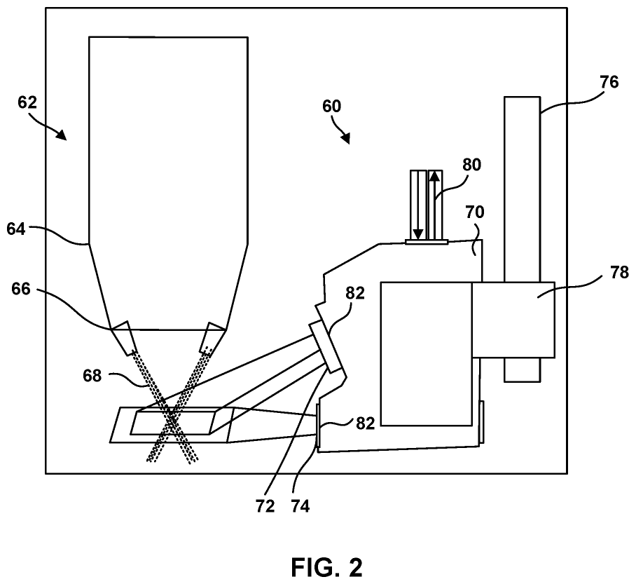

System 10 further includes at least one sensor 48. Sensor 48 may be configured to generate sensor data. The sensor data may be representative of at least one powder flow characteristic of powder flowing through system 10, in course of a process performed by system 10. For example, the at least one powder flow characteristic may include at least one of a includes at least one of a powder flow rate, an in situ powder velocity, an ex situ powder velocity, a carrier gas flow rate, a carrier gas pressure, a center purge flow rate, or a center purge pressure. Sensor 48 may include at least one of a powder flow monitor (e.g., a powder flow monitoring system described with reference to FIG. 2), an acoustic sensor, or an in-line gas flow sensor.

In some examples, sensor 48 includes at least one acoustic sensor. During operation of system 10, an acoustic signal (e.g., sound) may be generated by flow of powder through system 10, by interaction of powder with component 22 and/or melt pool 32, or by interaction of power with some component of system 10. The acoustic signal may be associated with one or more of a powder flow characteristic, a process parameter, or a condition of component 22 or a component of system 10. In some examples, in which sensor 48 includes at least one acoustic sensor configured to generate at least one time-dependent acoustic data signal representative of the acoustic signal generated in or by system 10.

The time-dependent acoustic data signal may be rich in information, and may include data representative of acoustic signals generated by powder flow, or by one or more component of system 10. The acoustic signals may also be representative of process parameters or variations in process parameters. For example, the acoustic signal generated by powder delivery device 14 may depend upon process attributes including, for example, geometry of powder delivery device 14, including wear of powder delivery device 14, material deposit within powder delivery device 14, powder flow rate through powder delivery device 14, powder flow pulsing, carrier gas flow rate, carrier gas pressure within powder delivery device 14, composition of powder, or the like. Similarly, the acoustic signal generated by powder flow through different portions, regions, or components of system 10, or toward melt pool 32, or incorporating with melt pool 32, may vary with variances in powder flow. In this way, computing device 12 may analyze the time-dependent acoustic data signal to determine whether powder flow and fabrication process parameters are within a nominal or expected range, or if the powder flow or fabrication process parameters varying compared to an expected value.

In some examples, sensor 48 includes a plurality of acoustic sensors, and respective acoustic sensors may be positioned near respective components of the system 10. In some examples, each acoustic sensor of the plurality of acoustic sensors may generate a respective at least one time-dependent acoustic data signal. Because of the different positions of the respective acoustic sensors, the computing device may analyze the respective time-dependent acoustic data signals to determine information related to respective components of system 10. For example, each respective time-dependent acoustic data signal may be associated with the respective component to which the respective acoustic sensor is near. Alternatively or additionally, the computing device may utilize the intensity of respective frequency components of at least one time-dependent acoustic data signal to determine, e.g., based on distance, to which component the sound may be attributed. In this way, the computing device may analyze the time-dependent acoustic data signal or time-dependent acoustic data signals to determine process attributes for a plurality of components of system 10.

The at least one acoustic sensor may be positioned external to a housing that holds one or more components of system 10, or may be positioned within the housing. The at least one acoustic sensor may include, for example, an acoustic sensing element such as a microphone or a sound-to-electric transducer or electromagnetic, capacitive, or piezoelectric elements that generate an electrical signal in response to incident sound waves.

The at least one acoustic sensor may be configured to sense acoustic signals with a predetermined wavelength or wavelength range. In some examples, the at least one acoustic sensor may be configured to sense acoustic signals that may or may not be detectable by human hearing, including infrasound and ultrasound. In some examples, the acoustic signals may include frequencies below about 20 Hz, from about 20 Hz to about 20 kHz, from about 20 kHz to about 2 MHz, higher than about 2 MHz, or combinations thereof. Each acoustic sensor of the at least one acoustic sensor is configured to generate a respective time-dependent acoustic data signal of at least one time-dependent acoustic data signal based on the sensed acoustic signal, and communicate at least one time-dependent acoustic data signal to computing device 12. In some examples, at least one time-dependent acoustic data signal includes a digital data signal, and at least one acoustic sensor includes an analog-to-digital converter. In other examples, at least one time-dependent acoustic data signal includes an analog signal. In some examples, the at least one acoustic sensor includes an amplifier to amplify the signal sensed by the at least one acoustic sensor and produce the at least one time-dependent acoustic data signal. The at least one acoustic sensor may transmit the at least one time-dependent acoustic data signal using electrical signals, Bluetooth, Wi-Fi, radio, or any other suitable transmission pathway.

In some examples, the at least one acoustic sensor may be configured to enhance detection of one acoustic signal compared to another acoustic signal. For instance, a first acoustic sensor of the at least one acoustic sensor may be positioned adjacent to a selected component of system 10, oriented toward a selected component of system 10, or the like to enhance detection of a selected acoustic signal compared to another acoustic signal. For example, a first acoustic sensor of the at least one acoustic sensor may be positioned to sense acoustic signals originating from powder delivery device 14, and a second acoustic sensor of the at least one acoustic sensor may be positioned to sense acoustic signals originating from powder source 42. The at least one acoustic sensor may be located near a component or at a zone within system 10, or may be oriented towards a component to sense sound from the component, or otherwise more accurately attribute the sound to a source. In an example, the at least one acoustic sensor may include multiple acoustic sensors forming an acoustic sensor network that captures sound generated by various components of system 10.

In some examples, sensor 48 includes at least one in-line gas flow sensor. The gas flow rate sensor may be configured to detect a flow rate of gas, for example, of gas flowing through powder delivery device 14, along flow path 46, or along some other component or conduit through which gas flows in system 10. The flow rate may include a volumetric flow rate or a mass flow rate of the gas. The in-line gas flow sensor may include additional sensors configured to detect one or more parameters of the gas flow. Such parameters of the gas flow may include, but are not limited to, a velocity of the gas flow, a mass flow rate of the gas flow, a volumetric flow rate of the gas flow, a turbulence of the gas flow, a volume fraction of the gas flow with respect to the powder flow, a composition of the gas flow, a temperature of the gas flow, or any other parameter of the gas flow that may affect a material property of the as-deposited layer and/or may be modified through deposition parameters of powder delivery device 14 and/or energy delivery device 16.

Computing device 12 is configured to control components and operation of system 10 and may include, for example, a desktop computer, a laptop computer, a workstation, a server, a mainframe, a cloud computing system, or the like. Computing device 12 may be communicatively coupled to, and configured to control, powder delivery device 14, energy delivery device 16, PFMS 18, stage 20, powder source 42, powder source mass sensor 44, sensor 48, optical system 50, and/or MPMS 52 using respective communication connections. Although FIG. 1 illustrates a single computing device 12 and attributes all control and processing functions to that single computing device 12, in other examples, system 10 may include multiple computing devices 12, e.g., a plurality of computing devices 12.

Computing device 12 may be configured to control operation of powder delivery device 14, energy delivery device 16, stage 20, and/or sensor 48 to position component 22 relative to powder delivery device 14, energy delivery device 16, PFMS 18, sensor 48, and/or MPMS 52, during additive manufacturing processes. For example, as described above, computing device 12 may control stage 20 and powder delivery device 14, energy delivery device 16, and/or sensor 48 to translate and/or rotate along at least one axis to position component 22 relative to powder delivery device 14, energy delivery device 16, PFMS 18, sensor 48, and/or MPMS 52. Positioning component 22 relative to powder delivery device 14, energy delivery device 16, PFMS 18, sensor 48, and/or MPMS 52 may include positioning a predetermined surface (e.g., a surface to which material is to be added) of component 22 in a predetermined orientation relative to powder delivery device 14, energy delivery device 16, PFMS 18, sensor 48, and/or MPMS 52.

Computing device 12 may be configured to control system 10 to deposit layers 24 and 26 to form component 22 based on a set of deposition parameters. The set of deposition parameters may include energy, feed, and motion parameters that are configured to produce layers 24, 26, having various physical parameters, such as a height of layers 24, 26, and a density of layers 24, 26. For example, the set of deposition parameters may include power, beam diameter, beam profile, and wavelength of energy delivery device 16; powder feed rate and gas feed rate of powder delivery device 14; scan speed and deposition path of stage 20 relative to energy delivery device 16 and powder delivery device 14; or any other operating parameters that may affect an amount and/or quality of material formed as layers 24, 26.

Computing device 12 may be configured to select deposition parameters that are configured to generate layers 24, 26, according to predetermined physical parameters. As shown in FIG. 1, component 22 may include a first layer 24 and a second layer 26, although many components may be formed of additional layers, such as tens of layers, hundreds of layers, thousands of layers, or the like. Component 22 in FIG. 1 is simplified in geometry and the number of layers compared to many components formed using additive manufacturing techniques. Although techniques are described herein with respect to component 22 including first layer 24 and second layer 26, the technique may be extended to components 22 with more complex geometry and any number of layers.

To form component 22, computing device 12 may control powder delivery device 14 and energy delivery device 16 according to the set of operating parameters to form, on a surface 28 of first layer 24 of material, a second layer 26 of material. Computing device 12 may control energy delivery device 16 to deliver energy 34 to a volume at or near surface 28 to form melt pool 32. For example, computing device 12 may control the relative position of energy delivery device 16 and stage 20 to direct energy to the volume. Computing device 12 also may control powder delivery device 14 to deliver powder stream 30 to melt pool 32. For example, computing device 12 may control the relative position of powder delivery device 14 and stage 20 to direct powder stream 30 at or on to melt pool 32.

Computing device 12 may control powder delivery device 14 and energy delivery device 16 to move energy 34 and powder stream 30 along build surface 28 in a pattern until layer 26 is complete. Computing device 12 may then control a z-axis position of stage 20 and/or powder delivery device 14 and energy delivery device 16 such that melt pool 32 will be formed on surface 36 of second layer 26, and may control powder delivery device 14 and energy delivery device 16 to move energy 34 and powder stream 30 along build surface 28 in a pattern until layer 26 is complete.

Computing device 12 may use sensor data from sensor 48 (alone, or in combination with sensor data from at least one other sensor) to monitor at least one powder flow characteristic in system 10, for example, to monitor a powder velocity. For example, computing device 12 may be configured to receive sensor data from sensor 48. Computing device 12 may be further configured to determine, based on the sensor data, at least one powder flow characteristic, and generate a signal indicative of the at least one powder flow characteristic. The at least one powder flow characteristic may include any suitable characteristic that may be associated with powder flow, including, for example, at least one of a powder flow rate, an in situ powder velocity, an ex situ powder velocity, a carrier gas flow rate, a carrier gas pressure, a center purge flow rate, or a center purge pressure.

An operator or computing device 12 may perform an action in response to the signal indicative of the at least one powder flow characteristic. For example, computing device 12 may be further configured to control, based on the at least one powder flow characteristic, energy delivery device 16 and/or powder delivery device 14 to deposit a plurality of layers based on a set of deposition parameters. Thus, the operator or computing device 12 may account for variances in powder flow in view of the deposition parameters to continue fabrication of component 22 (e.g., instead of interrupting or terminating fabrication). Alternatively, if powder flow deviates beyond acceptable thresholds, the operator or computing device 12 may interrupt or terminate fabrication, enabling further inspection of system 10 to assess possible causes of variances in powder flow.

In some examples, computing device 12 is further configured to determine, based on the at least one powder flow characteristic, at least one deposit quality metric or at least one abnormal event. For example, the at least one deposit quality metric may be indicative of geometric conformance of component 22 to a model based on which component 22 is fabricated, or other quality indicators based on partially built component 22, or of layers 24 or 26. The at least one abnormal event may include accumulation or formation of material within or on a nozzle. Presence of such material may cause at least one of clogging of a powder orifice or of a gas orifice, spattering, distortion of the powder stream, formation of fluggies or plugging. Fluggies are a deposit or localized buildup of molten or semi-molten material on a surface of a nozzle. Presence of fluggies on or around a powder or gas stream orifice may produce interruptions or inconsistencies in the powder stream and the subsequent build. Fluggies may be caused by splatter or rebounding of semi-molten particles from or around the melt pool. In some cases fluggies will grow to an extent that may clog or cover some or most of the nozzle opening.

Computing device 12 may also use sensor data from sensor 48 to determine a quality of component 22, for example, conformance of or deviation of component 22 compared to geometric tolerances. For example, computing device 12 may be configured to determine, based on the at least one powder flow characteristic, at least one process response. Computing device 12 may be further configured to determine, by comparing the process response with a threshold response value, the at least one quality metric. The at least one process response may be indicative of an aspect of component 22 influenced by a process performed by system 10. For example, the at least one process response may include at least one of a build quality, a build height, or a layer thickness.

Computing device 12 may modify operation of system 10 in response to the at least one powder flow characteristic, or in response a parameter determined based on the at least one powder flow characteristic). For example, computing device 12 may be further configured to adjust, based on the at least one deposit quality metric or at least one abnormal event, at least one powder control parameter. The at least one powder control parameter may include at least one of a powder feed rate, a carrier gas flow rate, a carrier gas pressure, a center purge flow rate, a center purge pressure, or a nozzle standoff distance.

FIG. 2 is a conceptual and schematic diagram illustrating an example powder flow monitoring system (PFMS) 60 configured to monitor powder flow between a powder delivery device 62 and a build surface (not shown in FIG. 2) during an additive manufacturing technique. Powder delivery device 62 may be an example of powder delivery device 14 of FIG. 1, and PFMS 60 may be an example of PFMS 18 of FIG. 1.

Powder delivery device 62 includes a deposition head 64 that carries a plurality of powder nozzles 66. Plurality of powder nozzles 66 output a powder stream 68 toward the build surface. As shown in FIG. 2, powder stream 68 may be focused at a focal plane, such that powder stream 68 is converging toward the focal plane and diverging away from the focal plane.

PFMS 60 includes a housing 70 (also referred to as an enclosure), which encloses an imaging device 72 and an illumination device 74. In some examples, imaging device 72 may be a high-speed camera and illumination device 74 may be laser illuminator. Housing 70 is attached to an adjustable z-stage 76 by a bracket 78.

Housing 70 is configured to enclose imaging device 72 and illumination device 74 and help protect imaging device 72 and illumination device 74 from a surrounding environment. For instance, housing 70 may be configured to surround imaging device 72 and illumination device 74 and prevent any powder that reflects from the build surface toward PFMS 60 from impacting imaging device 72 or illumination device 74.

Further, housing 70 may be configured to cool imaging device 72 and illumination device 74. Imaging device 72 and illumination device 74 may be exposed to heat from the melt pool at the build surface and energy from the energy delivery device. Imaging device 72 and illumination device 74 may be relatively sensitive to heat and have improved operational lifetime if maintained and operated below a certain temperature. PFMS 60 may include a cooling system 80 configured to remove heat from within housing 70 to cool imaging device 72 and illumination device 74. For instance, cooling system 80 may include cooling fluid circuit through which a cooling fluid flows, and housing 70 may include part of the cooling circuit. In some examples, housing 70 may be formed from a material having relatively high thermal conductivity, such as aluminum, to help transfer heat from within housing 70 to cooling system 80 (e.g., a cooling fluid flowing through cooling system 80).

As described above, PFMS 60 may be configured to measure powder flow of powder stream 68 (FIG. 2) at one or more axial (or longitudinal) locations of powder stream 68 and determine one or more parameters associated with the powder flow. For instance, illumination device 74 may illuminate powder of powder stream 68 in a plane oriented substantially orthogonal to a longitudinal axis that extends from powder delivery device 62 to the build surface. PFMS 60 may be positioned at a selected axial or longitudinal location to image a selected axial or longitudinal position between powder delivery device 62 and the build surface. Imaging device 72 may be configured to image at least some of the illuminated powder.

System 10 may be configured with various in-situ monitoring techniques, including powder flow monitoring, mass flux monitoring, and heat flux monitoring, to control an additive manufacturing process.

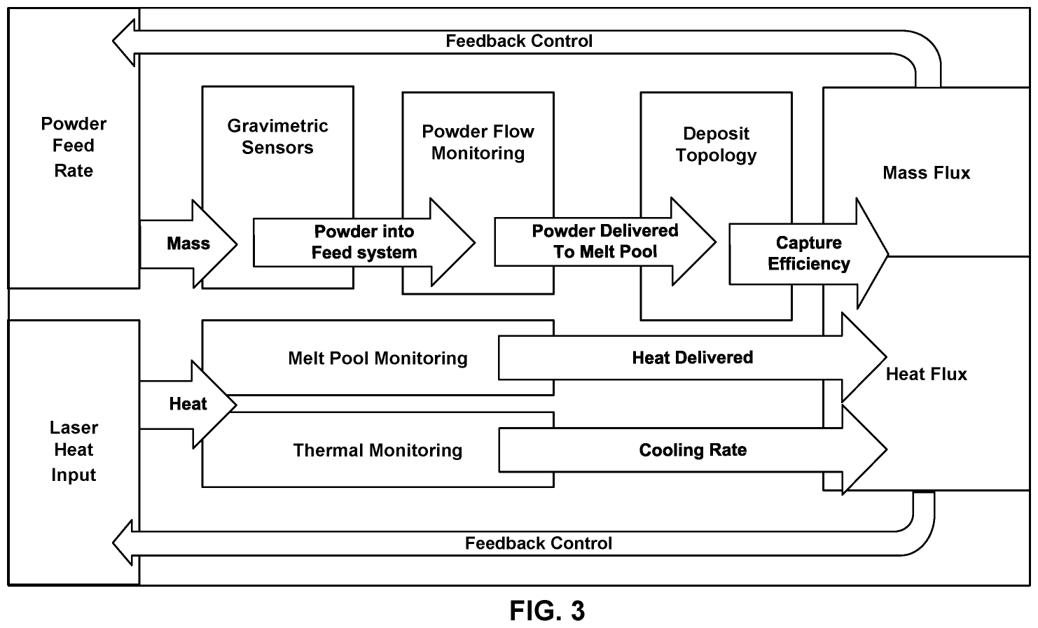

FIG. 3 is a process flow diagram illustrating a mass flux and heat flux monitoring and control technique. The technique of FIG. 3 may be implemented by system 10 of FIG. 1 or system 60 of FIG. 2 and will be described with concurrent reference to FIGS. 1 and 2. However, it will be appreciated that system 10 may perform other techniques and the technique of FIG. 3 may be performed by other systems.

Computing device 12 may be configured to monitor at least one powder flow characteristic, and control system 10 based on the at least one powder flow characteristic. For example, computing device 12 may be configured to control a powder feed rate output by powder source 42 (see top left of FIG. 3). For instance, computing device 12 may be configured to control an agitator of powder source 42, a gas flow rate of gas flowing through powder source 42, a position of one or more valves within flow path 46, or the like to control a powder feed rate output by powder source 42.

Computing device 12 may be configured to receive data from one or more mass flow monitoring sensors, including PFMS 18 and/or powder source mass sensor 44. Data received from powder source mass sensor 44 indicates a mass flow of powder from powder source 42 to powder delivery device. Data from PFMS 18 indicates a mass flow of powder in powder stream 30 between powder delivery device 14 to adjacent melt pool 32. In some examples computing device 12 may be configured to further receive sensor data from sensor 48. For example, sensor 48 may include a powder flow sensor, and data from sensor 48 may indicate a topology of build surface 28, and may further indicate powder mass captured by melt pool 32 and added to component 22.

Computing device 12 may calculate one or more mass flow-related metrics based on the data received from PFMS 18, powder source mass sensor 44, and/or sensor 48. For example, computing device 12 may determine a capture efficiency by determining a fraction or percentage of powder from powder stream 30 that is captured by melt pool 32 and added to component 22, e.g., by dividing the powder mass captured by melt pool 32, as determined based on data from powder flow sensor, into the mass flow determined based on data received from PFMS 18. Further, computing device 12 may determine an overall mass flux using the data received from PFMS 18, powder source mass sensor 44, and/or sensor 48. Computing device 12 then may use the overall mass flux as an input to the control algorithm used to control the powder feed rate output by powder source 42 (see top left of FIG. 3).

Similarly, computing device may be configured to control energy delivery device 16 to deliver energy 34 to first layer 24 to establish a given heat input (see bottom left of FIG. 3). For example, one or more computing device 12 may control one or more operating parameters of energy delivery device 16, such as intensity, pulse rate, pulse width, or the like; one or more positional parameters related to energy delivery device 16, such as dwell time at a location, a movement rate relative to first layer 24, an overlap between adjacent passes of energy 34 across first layer 24, a pause time between adjacent passes of energy 34 across first layer 24, or the like to control heat input to system 10 (e.g., to melt pool 32 and component 22).

Computing device 12 may be configured to receive data from one or more heat sensors, such as optical system 50 and/or MPMS 52. Computing device 12 may determine a cooling rate and associated heat from using data from optical system 50 and may determine a heat input into component using a size and/or temperature of melt pool 32 as observed by melt pool monitor. Computing device 12 may be configured to determine an overall heat flux using these data. Computing device 12 may then use the overall heat flux as an input to the control algorithm used to control the energy delivery by energy delivery device 16 (see bottom left of FIG. 3). In some examples, computing device 12 may also use a deposit topology (captured powder mass) and/or capture efficiency metric in the determination of the heat flux, as the added powder mass and quench effects associated with the captured powder affect the cooling rate.

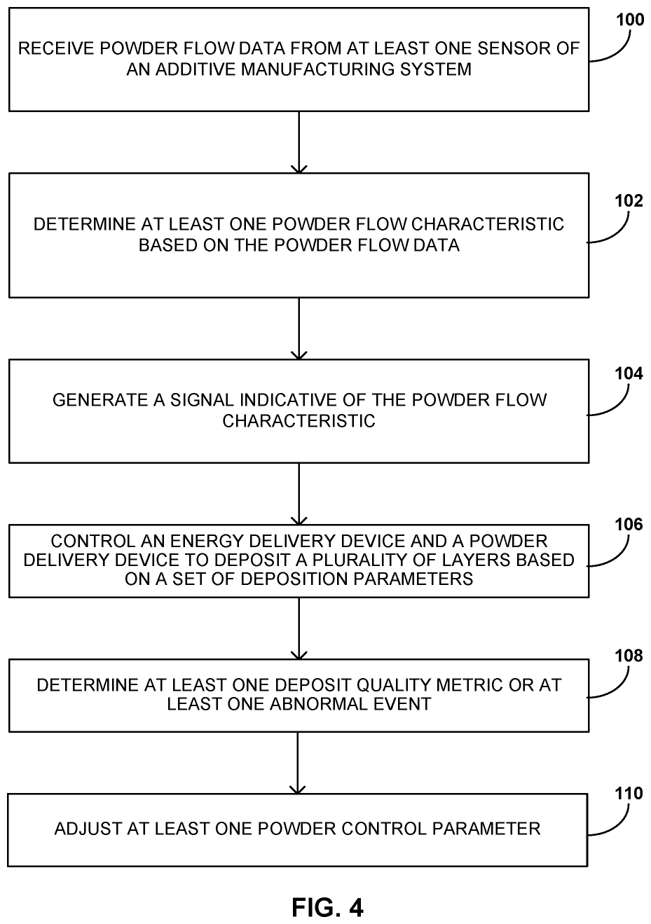

FIG. 4 is a flowchart illustrating an example technique for fabricating a component while monitoring a powder flow characteristic. The technique of FIG. 4 may be implemented by system 10 of FIG. 1 or system 60 of FIG. 2 and will be described with concurrent reference to FIGS. 1 and 2. However, it will be appreciated that system 10 may perform other techniques and the technique of FIG. 3 may be performed by other systems.

In some examples, the technique of FIG. 4 includes receiving, by computing device 12, sensor data from at least one sensor 48 of additive manufacturing system 10 (100). The sensor data is representative of at least one powder flow characteristic (associated with powder flowing through system 10). At least one sensor 48 may include at least one of a powder flow monitor, an acoustic sensor, or an in-line gas flow sensor.

The technique may further include determining, by computing device 12, based on the sensor data, at least one powder flow characteristic (102). The at least one powder flow characteristic may include at least one of a powder flow rate, an in situ powder velocity, an ex situ powder velocity, a carrier gas flow rate, a carrier gas pressure, a center purge flow rate, or a center purge pressure. Computing device 12 may use a predetermined correlation to determine the at least one powder flow characteristic based on the sensor data. The technique may further include generating, by computing device 12, a signal indicative of the powder flow characteristic (104). Computing device 12 may generate an output indicative of the signal, or may transmit the signal to another component, device, or system. An operator, or computing device 12, may take action in response to the signal. For example, the operator, or computing device 12, may interrupt or terminate operation of system 10, or modifying at least one process parameter of system 12, in response to the signal.

The technique may further include, controlling, by computing device 12, based on the at least one powder flow characteristic, energy delivery device 16 to deliver energy 34 to build surface 28 to form melt pool 32 and powder delivery device 14 to direct powder stream 30 toward melt pool 32 (106). Thus, computing device 12 may cause system 10 to deposit a plurality of layers based on a set of deposition parameters, accounting for the at least one powder flow characteristic. The controlling (106) may include, or be augmented by, determining other parameters of system 10. For example, the technique may further include determining, by computing device 12, based on the at least one powder flow characteristic and at least one component interaction parameter, a mass flux, and controlling, based on the at least one powder control parameter and the mass flux, energy delivery device 16 and powder delivery device 14 to deposit the plurality of layers. The at least one component interaction parameter includes at least one of a part geometry, a melt pool capture capability, or a tool path. Further, the technique may include, by computing device 12, at least one of: determining the part geometry based on a deposit topology; determining the melt pool capture capability based on melt pool size; or determining the tool path based on a build strategy.

The technique may further include determining, by computing device 12, at least one deposit quality metric or at least one abnormal event based on the at least one powder flow characteristic (108). The at least one abnormal event may include accumulation or formation of material within or on a nozzle, or any event indicating deviation of powder flow away from nominal flow characteristics. Presence of such material may cause at least one of clogging of a powder orifice or of a gas orifice, spattering, distortion of the powder stream, or plugging. Computing device 12 may assess a process response. For example, computing device 12 may determine at least one process response based on the at least one powder flow characteristic. The at least one process response may include at least one of a build quality, a build height, or a layer thickness. Computing device 12 may further determine the at least one quality metric by comparing the process response with a threshold response value. Thus, the quality metric may be indicative of conformance of component 22 to predetermined tolerances.

The technique may further include adjusting, by computing device 12, at least one powder control parameter based on the at least one deposit quality metric or the at least one abnormal event (110). For example, the at least one powder control parameter includes at least one of a powder feed rate, a carrier gas flow rate, a carrier gas pressure, a center purge flow rate, a center purge pressure, or a nozzle standoff distance. Thus, computing device 12 may monitor and control system 10 while accounting for powder flow conditions in course of fabricating component 22.

The following enumerated clauses describe various examples according to the present disclosure.

Clause 1: An additive manufacturing system, including: an energy delivery device configured to deliver energy to a build surface of a component to form a melt pool in the build surface of the component; a powder delivery device configured to direct a powder stream toward the melt pool; at least one sensor configured to generate sensor data; and a computing device configured to: receive the sensor data from the at least sensor; determine, based on the sensor data, at least one powder flow characteristic; generate a signal indicative of the at least one powder flow characteristic; and control, based on the at least one powder flow characteristic, the energy delivery device and the powder delivery device to deposit a plurality of layers based on a set of deposition parameters.

Clause 2: The additive manufacturing system of clause 1, where the at least one sensor includes at least one of a powder flow monitor, an acoustic sensor, or an in-line gas flow sensor.

Clause 3: The additive manufacturing system of clauses 1 or 2, where the at least one powder flow characteristic includes at least one of a powder flow rate, an in situ powder velocity, an ex situ powder velocity, a carrier gas flow rate, a carrier gas pressure, a center purge flow rate, or a center purge pressure.

Clause 4: The additive manufacturing system of any of clauses 1 to 3, where the computing device is further configured to determine at least one deposit quality metric or at least one abnormal event based on the at least one powder flow characteristic.

Clause 5: The additive manufacturing system of clause 4, where the at least one abnormal event includes accumulation or formation of material within or on a nozzle.

Clause 6: The additive manufacturing system of clauses 4 or 5, where the computing device is further configured to determine at least one process response based on the at least one powder flow characteristic.

Clause 7: The additive manufacturing system of clause 6, where the computing device is further configured to determine the at least one quality metric by comparing the process response with a threshold response value.

Clause 8: The additive manufacturing system of clauses 6 or 7, where the at least one process response includes at least one of a build quality, a build height, or a layer thickness.

Clause 9: The additive manufacturing system of any of clauses 4 to 8, where the computing device is further configured to adjust at least one powder control parameter based on the at least one deposit quality metric or the at least one abnormal event.

Clause 10: The additive manufacturing system of clause 9, where the at least one powder control parameter includes at least one of a powder feed rate, a carrier gas flow rate, a carrier gas pressure, a center purge flow rate, a center purge pressure, or a nozzle standoff distance.

Clause 11: A method for additive manufacturing, including: receiving, by a computing device, sensor data from at least one sensor of an additive manufacturing system; determining, by the computing device, based on the sensor data, at least one powder flow characteristic; generating, by the computing device, a signal indicative of the at least one powder flow characteristic; and controlling, by the computing device, based on the at least one powder flow characteristic, an energy delivery device and a powder delivery device of the additive manufacturing system to deposit a plurality of layers based on a set of deposition parameters.

Clause 12: The method of clause 11, where the at least one sensor includes at least one of a powder flow monitor, an acoustic sensor, or an in-line gas flow sensor.

Clause 13: The method of clauses 12 or 13, where the at least one powder flow characteristic includes at least one of a powder flow rate, an in situ powder velocity, an ex situ powder velocity, a carrier gas flow rate, a carrier gas pressure, a center purge flow rate, or a center purge pressure.

Clause 14: The method of any of clauses 11 to 13, further including determining, by the computing device, at least one deposit quality metric or at least one abnormal event based on the at least one powder flow characteristic.

Clause 15: The method of clause 14, where the at least one abnormal event includes accumulation or formation of material within or on a nozzle.

Clause 16: The method of clauses 14 or 15, further including determining, by the computing device, at least one process response based on the at least one powder flow characteristic.

Clause 17: The method of clause 15, further including determining, by the computing device, the at least one quality metric by comparing the process response with a threshold response value.

Clause 18: The method of clauses 16 or 17, where the at least one process response includes at least one of a build quality, a build height, or a layer thickness.

Clause 19: The method of any of clauses 14 to 18, further including adjusting, by the computing device, at least one powder control parameter based on the at least one deposit quality metric or the at least one abnormal event.

Clause 20: The method of clause 19, where the at least one powder control parameter includes at least one of a powder feed rate, a carrier gas flow rate, a carrier gas pressure, a center purge flow rate, a center purge pressure, or a nozzle standoff distance.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples have been described. These and other examples are within the scope of the following claims.

What is claimed is:

1. An additive manufacturing system, comprising:
an energy delivery device configured to deliver energy to a build surface of a component to form a melt pool in the build surface of the component;
a powder delivery device configured to direct a powder stream toward the melt pool;
at least one sensor configured to generate sensor data; and
a computing device configured to:
receive the sensor data from the at least sensor;
determine, based on the sensor data, at least one powder flow characteristic;
generate a signal indicative of the at least one powder flow characteristic; and
control, based on the at least one powder flow characteristic, the energy delivery device and the powder delivery device to deposit a plurality of layers based on a set of deposition parameters.

2. The additive manufacturing system of claim 1, wherein the at least one sensor comprises at least one of a powder flow monitor, an acoustic sensor, or an in-line gas flow sensor.

3. The additive manufacturing system of claim 1, wherein the at least one powder flow characteristic comprises at least one of a powder flow rate, an in situ powder velocity, an ex situ powder velocity, a carrier gas flow rate, a carrier gas pressure, a center purge flow rate, or a center purge pressure.

4. The additive manufacturing system of claim 1, wherein the computing device is further configured to determine at least one deposit quality metric or at least one abnormal event based on the at least one powder flow characteristic.

5. The additive manufacturing system of claim 4, wherein the at least one abnormal event comprises accumulation or formation of material within or on a nozzle.

6. The additive manufacturing system of claim 4, wherein the computing device is further configured to determine at least one process response based on the at least one powder flow characteristic.

7. The additive manufacturing system of claim 6, wherein the computing device is further configured to determine the at least one quality metric by comparing the process response with a threshold response value.

8. The additive manufacturing system of claim 6, wherein the at least one process response comprises at least one of a build quality, a build height, or a layer thickness.

9. The additive manufacturing system of claim 4, wherein the computing device is further configured to adjust at least one powder control parameter based on the at least one deposit quality metric or the at least one abnormal event.

10. The additive manufacturing system of claim 9, wherein the at least one powder control parameter comprises at least one of a powder feed rate, a carrier gas flow rate, a carrier gas pressure, a center purge flow rate, a center purge pressure, or a nozzle standoff distance.

11. A method for additive manufacturing, comprising:
receiving, by a computing device, sensor data from at least one sensor of an additive manufacturing system;
determining, by the computing device, based on the sensor data, at least one powder flow characteristic;
generating, by the computing device, a signal indicative of the at least one powder flow characteristic; and
controlling, by the computing device, based on the at least one powder flow characteristic, an energy delivery device and a powder delivery device of the additive manufacturing system to deposit a plurality of layers based on a set of deposition parameters.

12. The method of claim 11, wherein the at least one sensor comprises at least one of a powder flow monitor, an acoustic sensor, or an in-line gas flow sensor.

13. The method of claim 11, wherein the at least one powder flow characteristic comprises at least one of a powder flow rate, an in situ powder velocity, an ex situ powder velocity, a carrier gas flow rate, a carrier gas pressure, a center purge flow rate, or a center purge pressure.

14. The method of claim 11, further comprising determining, by the computing device, at least one deposit quality metric or at least one abnormal event based on the at least one powder flow characteristic.

15. The method of claim 14, wherein the at least one abnormal event comprises accumulation or formation of material within or on a nozzle.

16. The method of claim 14, further comprising determining, by the computing device, at least one process response based on the at least one powder flow characteristic.

17. The method of claim 16, further comprising determining, by the computing device, the at least one quality metric by comparing the process response with a threshold response value.

18. The method of claim 16, wherein the at least one process response comprises at least one of a build quality, a build height, or a layer thickness.

19. The method of claim 14, further comprising adjusting, by the computing device, at least one powder control parameter based on the at least one deposit quality metric or the at least one abnormal event.

20. The method of claim 19, wherein the at least one powder control parameter comprises at least one of a powder feed rate, a carrier gas flow rate, a carrier gas pressure, a center purge flow rate, a center purge pressure, or a powder standoff distance.
